(19) United States
(12) Patent Application Publication
(10) Pub. No.: US 2017/0364839 A1
(43) Pub. Date: Dec. 21, 2017

(54) INFORMATION PROCESSING DEVICE, MODEL CONSTRUCTION METHOD, AND PROGRAM RECORDING MEDIUM

(71) Applicant: NEC Corporation, Tokyo (JP)

(72) Inventor: Masato KAWATSU, Tokyo (JP)

(21) Appl. No.: 15/532,744

(22) PCT Filed: Dec. 2, 2015
(86) PCT No.: PCT/JP2015/005985

§ 371 Date: Jun. 2, 2017

(30) Foreign Application Priority Data
Dec. 5, 2014 (JP) 2014-246935

(51) Int. Cl. G06Q 10/04; G06Q 50/06

(52) U.S. Cl. CPC G06Q 10/04; G06Q 50/06

(57) ABSTRACT

The present invention discloses an information processing device, etc., for constructing as appropriate prediction model even when there exist a plurality of customers having different demand tendencies. An information processing device pertaining to the present invention includes: a means for dividing a plurality of contract units into a discretional number of groups on the basis of a feature corresponding to each of elements that could affect demand in the contract units, the feature varying with the time series of the demand; and a means for constructing, for each of the groups, a prediction model that represents the demand, and outputting the constructed prediction model.

### TECHNICAL FIELD

The present invention relates to a technology to construct a model and in particular, relates to a technology to construct a model for predicting demand.

### BACKGROUND ART

Various related technologies to construct a model are known.

For example, in patent literature 1, there is disclosed an adaptive prediction model construction system. In the adaptive prediction model construction system described in patent literature 1, the prediction model is constructed by using past time-series data and when an error of the prediction value outputted from the prediction model is greater than a first threshold value, the prediction model is updated. Further, in the adaptive prediction model construction system, when the error of the prediction value is greater than a second threshold value, a model construction of the prediction model is also updated. Further, in the adaptive prediction model construction system, clustering of the past time-series data is performed and the prediction model is constructed for each cluster.

Further, in patent literature 2, there is disclosed a variable prediction model construction system. In the variable prediction model construction system described in patent literature 2, the prediction model is constructed for each of a plurality of learning periods of 7 to 70 days by using learning data obtained by correcting the time-series data (removing or correcting an abnormal value). Next, in the variable prediction model construction system, modeling accuracy evaluation (modeling error comparison) of each learning period is performed and the most suitable learning period and prediction model with the highest prediction accuracy are selected. Further, in the variable prediction model construction system, a day of the week and temperature information are used for a parameter of the prediction model as an explanatory variable in addition to demand data. Furthermore, in the variable prediction model construction system, a specific temperature is used as a segmentation boundary, the time-series data is divided into segments, and the prediction model corresponding to each of the segmented time-series data is constructed.

### CITATION LIST

### Patent Literature

PTL 1: Japanese Patent Application Laid-open Publication No. 202004-086896

PTL 2: Japanese Patent Application Laid-open Publication No. 2009-237832

### SUMMARY OF INVENTION

### Technical Problem

However, in the technology described in patent literature in the citation list, a problem in which an inappropriate prediction model is constructed when a plurality of consumers having different demand tendencies exist occurs.

This is because in the technology described in patent literature in the citation list above, the following point is not taken into consideration. The consumers have different demand tendencies from each other, in other words, the appropriate prediction model is different for each consumer.

Specifically, in the adaptive prediction model construction system described in the patent literature 1, the prediction model is constructed for each cluster. However, when many different consumers exist, the adaptive prediction model construction system can not necessarily guarantee the construction of the appropriate prediction model by performing general clustering of the time-series data.

Further, in the variable prediction model construction system described in the patent literature 2, as a parameter of the prediction model, a day of the week and temperature information are used as an explanatory variable and a plurality of prediction models corresponding to a specific temperature range are constructed. However, when many different consumers exist, the adaptive prediction model construction system can not necessarily guarantee the construction of the appropriate prediction model by only dividing the time-series data according to the temperature range,

An object of the present invention is to provide an information processing device, a model construction method, and a program recording medium therefor which can solve the above-mentioned problem.

### Solution to Problem

An information processing device according to one aspect of the present invention includes:
classification means for classifying a plurality of contract units into an arbitrary number of groups based on a feature of a demand that changes in chronological order corresponding to each of elements which is capable of influencing the demand regarding the contract unit; and
model construction means for constructing a prediction model that is a model for predicting the demand with respect to each group and outputting the constructed prediction model.

A model construction method according to one aspect of the present invention includes:
classifying a plurality of contract units into an arbitrary number of groups based on a feature of a demand that changes in chronological order corresponding to each of elements which is capable of influencing the demand regarding the contract unit; and
constructing a prediction model that is a model for predicting the demand with respect to each group and outputting the constructed prediction model
by a computer.

In addition, the object is also achieved by a computer program that achieves the model construction method having the above-described configurations with a computer, and a computer-readable recording medium that stores the computer program.

### Advantageous Effects of Invention

The present invention has an effect in which even when a plurality of consumers having different demand tendencies exist, the appropriate prediction model can be constructed.

### BRIEF DESCRIPTION OF DRAWINGS

FIG. 1 is a block diagram showing a configuration of an information processing device according to a first example embodiment of the present invention.

FIG. 2 is a block diagram showing a hardware configuration of a computer for realizing an information processing device according to a first example embodiment.

FIG. 3 is a figure showing an example of electric power demand data in a first example embodiment.

FIG. 4 is a figure showing an example of meteorological data in a first example embodiment.

FIG. 5 is a figure showing an example of a typical pattern list in a first example embodiment.

FIG. 6 is a figure showing an example of an explanatory variable set list in a first example embodiment.

FIG. 7 is a flowchart showing operation of an information processing device according to a first example embodiment.

FIG. 8 is a block diagram showing a configuration of an information processing device according to a modification example of a first example embodiment.

FIG. 9 is a block diagram showing a configuration of an information processing device according to a second example embodiment of the present invention.

FIG. 10 is a flowchart showing operation of an information processing device according to a second example embodiment.

FIG. 11 is a block diagram showing a configuration of an information processing device according to a third example embodiment of the present invention.

### DESCRIPTION OF EMBODIMENTS

Example embodiment of the present invention will be described in detail with reference to a drawing. Further, in each drawing and each example embodiment described in this description, the same reference numbers are used for the elements having the same function as those elements previously described and the description of the element will be omitted appropriately. Further, in the drawing, a direction of an arrow is shown as an example. Therefore, the direction of the signal between blocks is not limited to the arrow direction shows in the figure.

### First Example Embodiment

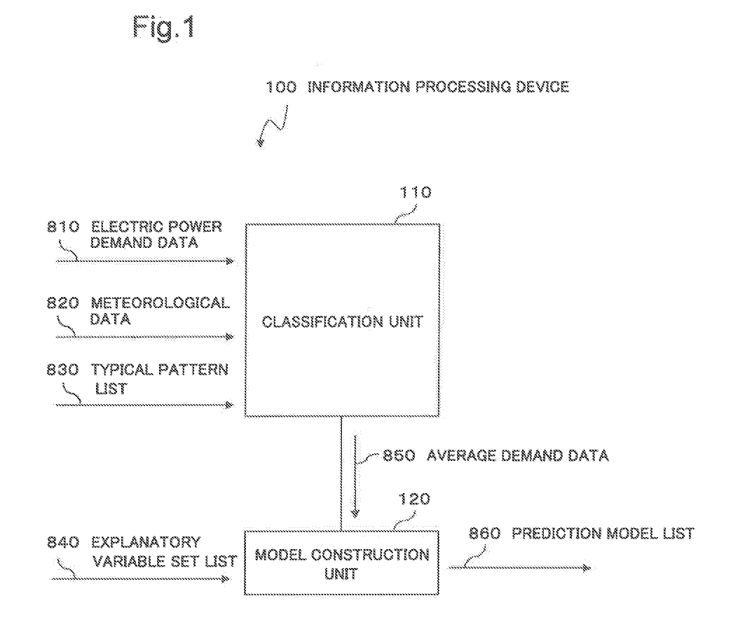

FIG. 1 is a block diagram showing a configuration of an information processing device 100 according to a first example embodiment of the present invention. As shown in FIG. 1, the information processing device 100 according to this exemplary embodiment includes a classification unit 110 and a model construction unit 120.

Each component shown in FIG. 1 may be a hardware circuit, a module included in a microchip, or a functional component of which a computer device is composed. Here, it is assumed that the component shown in FIG. 1 is the functional component of which the computer device is composed and the explanation will be made based on this assumption. Further, the information processing device 100 shown in FIG. 1 may be mounted on a certain server and used via a network. Further, each component shown in FIG. 1 may be dispersedly disposed on the network and used.

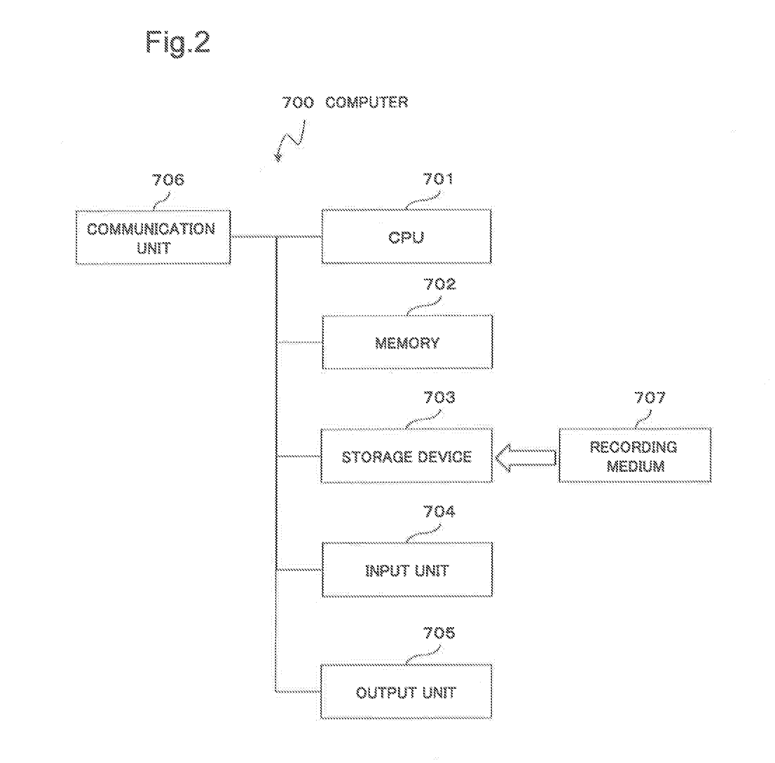

FIG. 2 is a figure showing a hardware configuration of a computer 700 which realizes the information processing device 100 according to this example embodiment.

As shown in FIG. 2, the computer 700 includes a CPU (Central Processing Unit) 701, a memory 702, a storage device 703, an input unit 704, an output unit 705, and a communication unit 706. Further, the computer 700 includes a recording medium (or a storage medium) 707 supplied from the outside. For example, the recording medium 707 is a nonvolatile recording medium (non-transitory recording medium) storing information in a non-transitory manner. Further, the recording medium 707 may be a transitory recording medium which holds information as a signal.

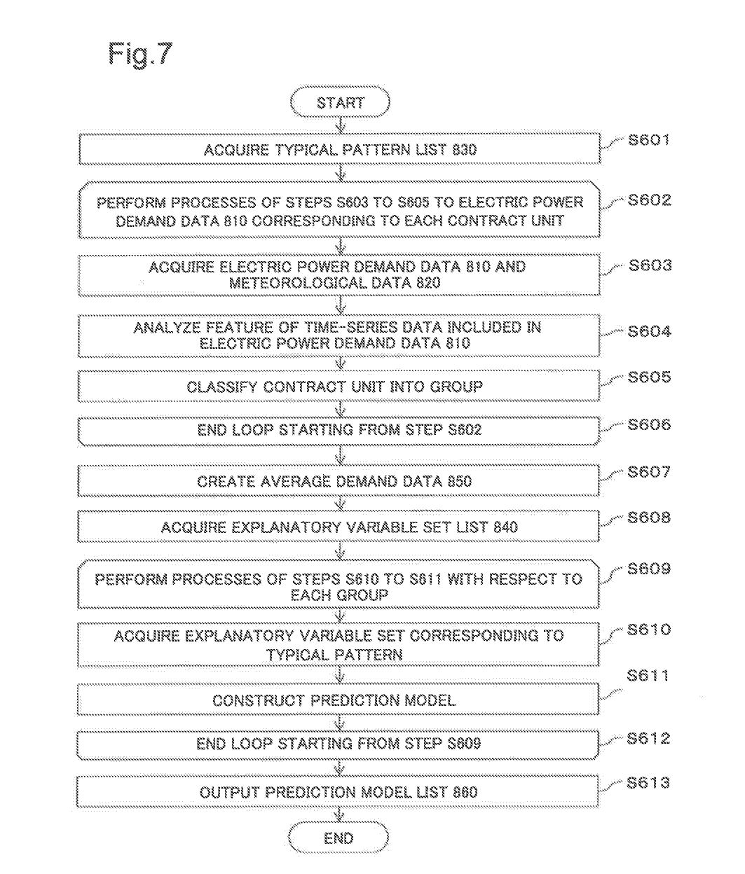

The CPU 701 executes an operating system (not shown) to control the whole operation of the computer 700. For example, the CPU 701 reads the program and data from the recording medium 707 mounted on the storage device 703 and writes the read program and data in the memory 702. The program is a program which causes the computer 700 to perform the operation shown in the flowchart of FIG. 7 described later.

The CPU 701 executes various processes as the classification unit 110 and the model construction unit 120 shown in FIG. 1 according to the read program and based on the read data.

Further, the CPU 701 may download the program and data from an external computer (not shown) connected to a communication network (not shown) and store them in the memory 702.

The memory 702 stores the program and the data. The memory 702 may store electric power demand data 810 (described later), meteorological data 820 (described later), typical pattern list 830 (described later), explanatory variable set list 840 (described later), prediction model list 860 (described later), and the like. The memory 702 may be included in the classification unit 110 and the model construction unit 120 as a part of them.

The storage devices 703 is for example, an optical disc, a flexible disc, a magneto optical disc, an external hard disk semiconductor memory, or the like and includes the recording medium 707. The storage device 703 (the recording medium 707) stores the program in a computer-readable manner. Further, the storage device 703 may store the data. The storage device 703 may store the electric power demand data 810 (described later), the meteorological data 820 (described later), the typical pattern list 830 (described later), the explanatory variable set list 840 (described, later), the prediction model list 860 (described later), and the like. The storage device 703 may be included in the classification unit 110 and the model construction unit 120 as a part of them.

The input unit 704 receives data inputted by the operator's operation and information inputted from the outside. The device used for the input operation is for example, a mouse, a keyboard, a built-in key button, a touch panel, or the like. The input unit 704 may be included in the classification unit 110 and the model construction unit 120 as a part of them.

The output unit 705 is realized by for example, a display. The output unit 705 is used for displaying for example, a message requesting the operator to perform an input operation by using a GUI (GRAPHICAL User Interface), the output to the operator, or the like. The output unit 705 may be included in the classification unit 110 and the model construction unit 120 as a part of them.

The communication unit 706 realizes an interface with the external device (not shown). The communication unit 706 may be included in the classification unit 110 and the model construction unit 120 as a part of them.

As described above, each functional component of which the information processing device 100 shown in FIG. 1 is composed is realized by the computer 700 having the hardware configuration shown in FIG. 2. However, means for realizing each unit included in the computer 700 are not limited to the above-mentioned method. Namely, the computer 700 may be realized by one physically combined device or two or more devices that are physically separated from one another and connected by wire or wireless to each other.

Further, when the recording medium 707 recording a code of the above-mentioned program is supplied to the computer 700, the CPU 701 may read the code of the program stored in the recording medium 707 and execute it. Alternatively, the CPU 701 may store the code of the program stored in the recording medium 707 in the memory 702, the storage device 703, or both of them. Namely, this example embodiment includes an example embodiment of the recording medium 707 which transitory or non-transitory stores the program (software) executed by the computer 700 (CPU 701). Further, the storage medium that non-transitory stores information is also called a nonvolatile storage medium.

Each hardware component of the computer 700 for realizing the information processing device 100 according to this example embodiment has been explained above.

The functional component of which the information processing device 100 is composed will be described with reference to FIG. 1.

### Classification Unit 110

The classification unit 110 classifies a plurality of contract units into an arbitrary number of groups based on the feature of the demand changing in chronological order corresponding to each of the elements which is possible to influence the demand regarding the contract unit.

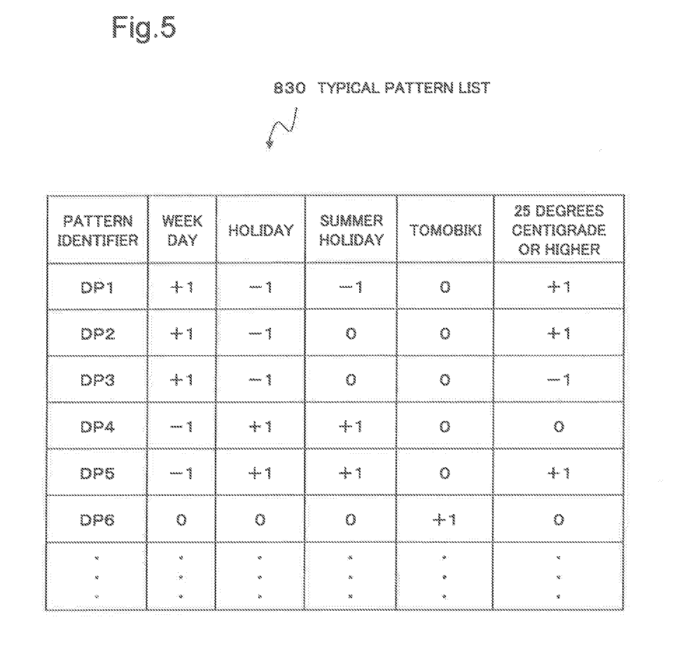

In other words, first, the classification unit 110 analyzes the feature corresponding to each of the above-mentioned elements for each contract unit. Secondly, the classification unit 110 classifies the contract units having a predetermined similarity to each other in characteristic patterns into the same group. Here, the characteristic pattern of the contract unit is a pattern indicated by a combination of the features corresponding to the above-mentioned element. Specifically, the characteristic pattern has a structure that is the same as that of the typical pattern included in the typical pattern list 830 shown in FIG. 5 described later.

Here, the contract is, for example, an electric power use contract between an electric power provider which provides an electric power and a consumer using the electric power. In this case, the demand regarding each of the contracts is an electric power use amount according to the electric power use contract. Further, the contract treated as the contract unit may be an arbitrary contract between a provider and a consumer such as a regular purchase contract on gas supplies, water supplies, food supplies, or the like, a contract for using a cloud system, or the like.

The element is, for example, a specific period of time (for example, 9:00 to 17:00), a specific day of the week (for example, Monday, Saturday and Sunday), a specific school holiday period (for example, summer holiday), a specific special day on calendar (for example, Bon, New Year's day, Christmas, Taian, Tomobiki), or the like. In general, the above-mentioned element is also called as a specific period on the time axis.

Further, the elements is temperature (for example, T degrees centigrade or higher (T is a real number), T degrees centigrade or lower, the latest lowest temperature), rainfall (a rainfall amount is equal to or greater than R mm per one hour (R is a positive real number)), wind (the maximum wind speed is equal to or greater than X meters per second (X is a positive real number)), or the like. In general, the above-mentioned element is called a specific meteorological condition.

In a case in which the demand is defined as the “electric power use amount”, the chronological change in demand is for example, the change of the electric power use amount per a predetermined time period (for example, 30 minutes).

The feature (the feature of the demand that changes in chronological order) corresponding to the element may be represented by responsiveness of the demand with respect to the element. Specifically, the feature in ease where the demand (the electric power use amount) increases with respect to the element “Sunday” is “the demand has the positive responsiveness with respect to the element “Sunday””. The feature in case where the demand (the electric power use amount) decreases on the element (“Sunday”) is “the demand has the negative responsiveness with respect to the element “Sunday””. The feature in case where the difference between the demand (the electric power use amount) on the element “Sunday” and the demand (the electric power use amount) on the day other than Sunday is equal to or smaller than a predetermined threshold value is “the demand has no responsiveness with respect to the element “Sunday””. In this case, each amount of the features may be represented by “1”, “−1”, and “0” for the “positive” responsiveness, the “negative” responsiveness, and “no” responsiveness, respectively. Alternatively, the amount of the feature may be represented by a continuous value corresponding to the difference between the demand on the element “Sunday” and the demand on the day other than Sunday.

Specifically, first, for example, the classification unit 110 standardizes the time-series data of the demand (for example, electric power demand data) during an arbitrary appropriate period (the classification unit 110 regards the time-series data of the demand as data with normal distribution and converts it into the standard normal distribution) and analyzes the feature for each element with respect to each contract unit. In this case, the classification unit 110 may associate the time-series data of the demand with the element based on the calendar or the like with respect to the element that is the specific period on the time axis. Further, the classification unit 110 may associate the time-series data of the demand with the element based on the time-series data of meteorological information with respect to the element that is the specific meteorological condition.

Secondly, the classification unit 110 classifies the contract units having a predetermined similarity to each other in characteristic patterns into the same group. For example, the classification unit 110 classifies each contract unit into the group corresponding to each of the typical patterns. Here, the typical pattern is information indicated by the combination (pattern) of the definition (feature) of the responsiveness corresponding to the element included in the typical pattern list 830 shown in FIG. 5 described later. The characteristic pattern has a structure that is the same as that of the typical pattern.

In other words, the group into which each contract unit is classified is the group corresponding to the typical pattern having the pattern similar to the characteristic pattern indicated by the contract unit. The classification unit 110 may calculate a similarity between the characteristic pattern indicated by the contract unit and the typical pattern, and classify each contract unit based on a similarity degree score. Further, the classification unit 110 may determine a correspondence between the characteristic pattern indicated by each contract unit and each typical pattern (the group corresponding to the typical pattern) by a discrimination process. The classification unit 110 may determine the similarity between the characteristic pattern indicated by each contract unit and each typical pattern by a pattern matching process.

The classification unit 110 may classify a plurality of the contract units into an arbitrary number of groups based on the feature of the demand that changes in chronological order of the contract unit by an arbitrary appropriate means in spite of the above-mentioned example.

Model Construction unit 120

The model construction unit 120 constructs the prediction model that is the model for predicting the demand for each group and outputs the constructed prediction model.

For example, the model construction unit 120 acquires the explanatory variable set based on the typical pattern corresponding to the group. Next, the model construction unit 120 constructs the prediction model regarding the group by using the acquired explanatory variable set. At this time, for example, the model construction unit 120 constructs the prediction model for the average value of the demand in each contract unit included in the group.

Further, the model construction unit 120 may construct the prediction model for the demand for each of the contract units included in the group. In this case, many computer resources are required for the construction of the prediction model. Further, the computer resources corresponding to the number of the prediction models may be needed when the demand is predicted by using the constructed prediction model.

### Electric Power Demand Data 810

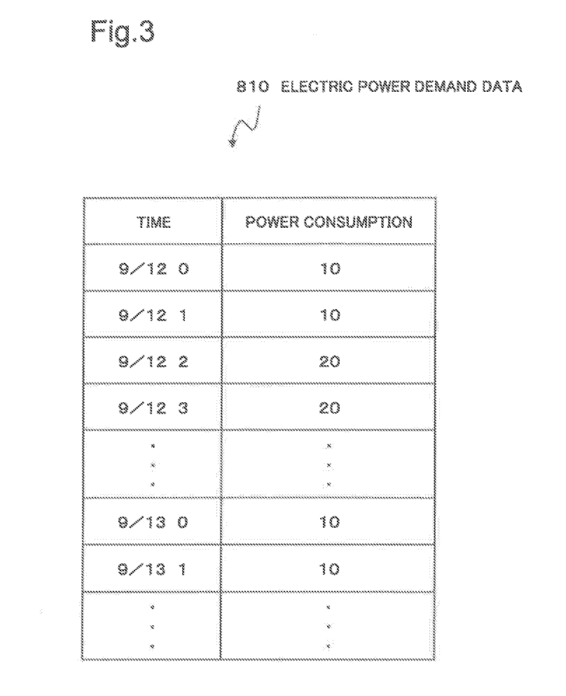

FIG. 3 is a figure showing an example of the electric power demand data 810 in this example embodiment. The electric power demand data 810 shown in FIG. 3 is time-series data including the record indicating the power consumption per 1 hour (KWk) of one contract unit.

In FIG. 3, in a “time” column, a date (for example, 9/12) and a time (for example, 0 (Indicating 0 a.m.)) are shown. Further, in a “power consumption” column, a power consumption per 1 hour is shown (for example, when the time indicated in the time column is “0 (0 a.m.), the power consumption per 1 hour consumed from 0:00 to 0:59 is shown). Further, in spite of the example shown in FIG. 3, the electric power demand data 810 may include a record indicating the power consumption per arbitrary appropriate unit time.

### Meteorological Data 820

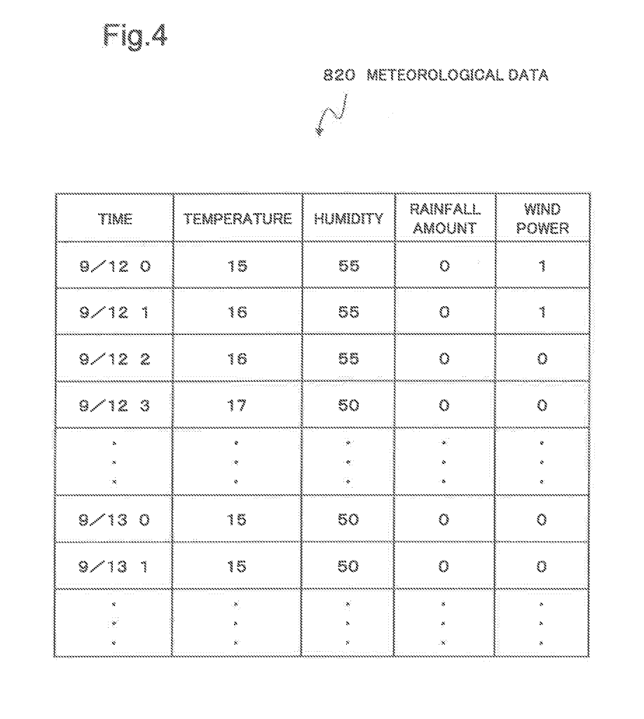

FIG. 4 is a FIG. showing an example of the meteorological data 820 in this example embodiment. The meteorological data 820 shown in FIG. 4 is time-series data including the record showing a meteorological condition for each one hour. Because the meteorological condition in a predetermined area is different from that in another area, the meteorological data 820 is required for each contract unit that exists in the area.

In FIG. 4, in a “time” column, a date (for example, 9/12) and a time (for example, 0 (indicating 0 a.m.)) are shown. Further, in a “temperature” column, temperature measured on the hour is shown (for example, when the time indicated in the time column is “0 (0 a.m.), the temperature measured at 0:00 a.m. is shown). For example, in a “humidity” column, humidity measured on the hour is shown (for example, when the time indicated in the time column is “0 (0 a.m.), the humidity measured at 0:00 a.m. is shown). For example, in a “rainfall amount” column, a rainfall amount per 1 hour is shown (for example, when the time indicated in the time column is “0 (0 a.m.), the rainfall amount per 1 hour measured from 0:00 to 0:59 is shown). In a “wind power” column, an average wind power per 1 hour is shown (for example, when the time indicated in the time column is “0 (0 a.m.). the average wind power per 1 hour measured from 0:00 to 0:59 is shown). Further, in spite of the example shown in FIG. 4, the meteorological data 820 may include a record indicating the meteorological condition per arbitrary appropriate unit time. Further, in spite of the example shown in FIG. 4, the meteorological data 820 may include a record indicating an item of the arbitrary appropriate meteorological condition.

### Typical Pattern List 830

FIG. 5 is a figure showing an example of a typical pattern list 830 in this example embodiment. The typical pattern list 830 shown in FIG. 5 includes a record showing a typical pattern. In FIG. 5, a pattern identifier is an identifier of the typical pattern. Each record shows a combination of a definition (feature) of the responsiveness corresponding to five elements of “weekday”, “holiday”, “summer holiday”, “Tomobiki”, and “25 degrees centigrade or higher” to the pattern identifier. In FIG. 5, the signs of “+1”, “−1”, and “0” indicate that the element has the “positive responsiveness”, the “negative responsiveness”, and “no responsiveness”, respectively.

### Explanatory Variable Set List 840

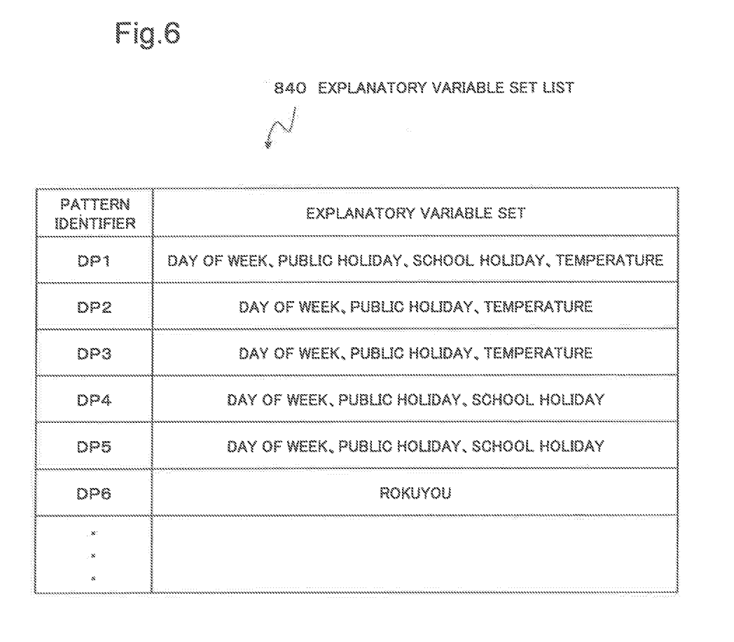

FIG. 6 is a FIG. showing an example of the explanatory variable set list 840 in this example embodiment. The explanatory variable set list 840 shown in FIG. 6 includes a record indicating a set of the pattern identifier and the explanatory variable set corresponding to the pattern identifier.

For example, a set of “day of week, public holiday, school holiday, and temperature” that is the explanatory variable set of a pattern identifier “DP1” shown in FIG. 6 corresponds to the typical pattern of the pattern identifier “DPI” shown in FIG. 5. Namely, the element “weekday” of the typical pattern of the pattern identifier “DPI” is modeled by “day of week” of the explanatory variable set. Similarly, the element “holiday” is modeled by “day of week” and “public holiday” of the explanatory variable set. The element “summer holiday” is modeled by “school holiday” of the explanatory variable set. The element “25 degrees centigrade or higher” is modeled by “temperature” of the explanatory variable set.

Each functional component of which the information processing device 100 is composed has been described above.

Next, the operation of this example embodiment will be described in detail with reference to a drawing.

FIG. 7 is a flowchart showing the operation of this example embodiment. Further, the process shown in this flowchart may be performed based on the program control by the CPU 701 mentioned above. Further, the step name of the process is shown by using a code such as “S601”.

For example, when the information processing device 100 receives an instruction from an operator via the input unit 704 shown in FIG. 2, the information processing device 100 starts to perform the operation shown in the flowchart of FIG. 7. When the information processing device 100 receives a request from the outside via the communication unit 706 shown in FIG. 2, the information processing device 100 may start to perform the operation shown in the flowchart of FIG. 7.

The classification unit 110 acquires the typical pattern list 830 (step S601), For example, the typical pattern list 830 may be stored in the memory 702 or the storage device 703 shown in FIG. 2 in advance. Further, the classification unit 110 may acquire the typical pattern list 830 inputted by the operator via the input unit 704 shown in FIG. 2. Further, the classification unit 110 may receive the typical pattern list 830 from an equipment (not shown) via the communication unit 706 shown in FIG. 2. Further, the classification unit 110 may acquire the typical pattern list 830 recorded in the recording medium 707 via the storage device 703 shown in FIG. 2.

The classification unit 110 performs the processes of steps S603 to S605 regarding ail the records of the electric power demand data 810 corresponding to each contract unit (step S602).

The classification unit 110 acquires the electric power demand data 810 regarding one contract unit and the meteorological data 820 corresponding to the electric power demand data 810 (step S603).

For example, the electric power demand data 810 and the meteorological data 820 may be stored in the memory 702 or the storage device 703 shown in FIG. 2 in advance. Further, the classification unit 110 may acquire the electric power demand data 810 and the meteorological data 820 that are inputted by the operator via the input unit 704 shown in FIG. 2. Further, the classification unit 110 may receive the electric power demand data 810 and the meteorological data 820 from the equipment (not shown) via the communication unit 706 shown in FIG. 2. Further, the classification unit 110 may acquire the electric power demand data 810 and the meteorological data 820 recorded in the recording medium 707 via the storage device 703 shown in FIG. 2.

Next, the classification unit 110 analyzes the feature of the time-series data included in the electric power demand data 810 based on the meteorological data 820 and calendar information for each element included in the typical pattern list 830 (step S604). It is assumed that the classification unit 110 stores the calendar information in advance. Further, the classification unit 110 may acquire the calendar information by using a method that is the same as that used for the typical pattern list 830.

Next, the classification unit 110 associates the typical pattern that is the most similar to the feature pattern among the typical patterns included in the typical pattern list 830 with the contract unit based on the feature analyzed in step S604 (step S605). In other words, the classification unit 110 classifies the contract unit into the group corresponding to the typical pattern that is the most similar to the feature pattern the contract unit represents based on the feature analyzed in step S604.

When the classification unit 110 completes the processes of steps S603 to S605 regarding all the contract units, a loop started from step S6021 ends. The process proceeds to step S607 (step S606).

Next, the classification unit 110 calculates, for each group, the average value of the power consumption per hour with respect to the electric power demand data 810 of each contract unit included in the group and generates the average demand data 850 (step S607). The average demand data 850 has a structure that is the same as that of the electric power demand data 810 and includes the calculated average value as the power consumption.

Next, the model construction unit 120 acquires the explanatory variable set list 840 (step S608). For example, the explanatory variable set list 840 may be stored in the memory 702 or the storage device 703 shown in FIG. 2 in advance. Further, the model construction unit 120 may acquire the explanatory variable set list 840 inputted by the operator via the input unit 704 shown in FIG. 2. Further, the model construction unit 120 may receive the explanatory variable set list 840 from an equipment (not shown) via the communication unit 706 shown in FIG. 2. Further, the model construction unit 120 may acquire the explanatory variable set list 840 recorded is the recording medium 707 via the storage device 703 shown in FIG. 2.

The model construction unit 120 performs the processes of steps S610 to S611 regarding all the groups (step S609).

Next, the model construction unit 120 acquires, from the explanatory variable set list 840, the explanatory variable set corresponding to the typical pattern of a certain group (step S610).

Next, the model construction unit 120 constructs the prediction model based on the average demand data 850 and the explanatory variable set corresponding to the group (step S611). The method for constructing the prediction model is not limited in particular. However, for example, the method described in patent literature 1 or patent literature 2 can be used.

After the model construction unit 120 performs the processes of the steps S610 to S611 to all the groups, the process proceeds to step S613 (step S612).

Next, the model construction unit 120 outputs the prediction model list 860 in which the prediction model regarding each group is listed (step S613). After performing this process, the process ends.

For example, the model construction unit 120 outputs the prediction model list 860 via the output unit 705 shown in FIG. 2, Further, the model construction unit 120 may transmit the prediction model list 860 to an equipment (not shown) via the communication unit 706 shown in FIG. 2. Further, the model construction unit 120 may record the prediction model list 860 in the recording medium 707 via the storage device 703 shown in FIG. 2.

Further, the model construction unit 120 may output information indicating the correspondence between each contract unit and each group, information of the typical pattern corresponding to each group, and information of the explanatory variable set corresponding to the typical pattern in addition to the prediction model list 860 in a format that is recognizable to the person.

According to the example embodiment mentioned above, a first advantageous effect in which the appropriate prediction model can be constructed, even when a plurality of consumers having different demand tendencies exist is obtained.

This is because the classification unit 110 classifies the contract units into the group based on the feature of the demand changing in chronological order with respect to each contract unit and the model construction unit 120 constructs the prediction model for each group and outputs it.

According to the example embodiment mentioned above, a second advantageous effect in which the computer resource for constructing the prediction model can be saved is obtained.

This is because the classification unit 110 generates the average demand data 850, and the model construction unit 120 constructs the prediction model for each group using the average demand data 850.

### <Modification Example of First Example Embodiment>

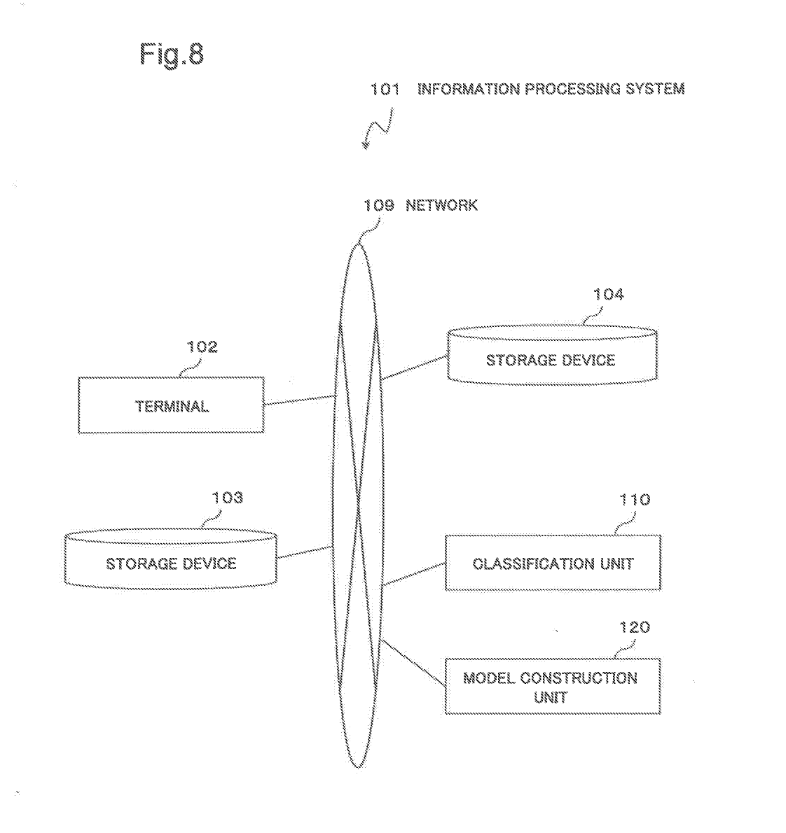

FIG. 8 is a figure showing an information processing device 101 according to a modification example of the first example embodiment. As shown in FIG. 8, the information processing system 101 includes the classification unit 110 and the model construction unit 120 of the information processing device 100 shown in FIG. 1, a terminal 102, a storage device 103, and a storage device 104. The classification unit 110, the model construction unit 120, the terminal 102, the storage device 103, and the storage device 104 are connected to each other via a network 109. Further, an arbitrary combination of the classification unit 110, the model construction unit 120, the terminal 102, the storage device 103, and the storage device 104 may be one computer 700 as shown in FIG. 2. Further, any two components among the classification unit 110, the model construction unit 120, the terminal 102, the storage device 103, and the storage device 104 may be directly connected to each other without being connected via the network. Namely, the arbitrary components among the classification unit 110, the model construction unit 120, the terminal 102, the storage device 103, and the storage device 104 can be connected to each other via the network 109.

### Terminal 102

The terminal 102 instructs the classification unit 110 to generate the prediction model in response to the instruction from the operator. Further, the terminal 102 outputs the prediction model list 860 received from the model construction unit 120 (for example, the terminal 102 displays the prediction model list 860 to the operator).

### Storage Device 103

The storage device 103 stores the electric power demand data 810 and the prediction model list 860.

### Storage Device 104

The storage device 104 stores the meteorological data 820, the typical pattern list 830, and the explanatory variable set list 840.

According to the modification example of this example embodiment, an advantageous effect in which the information processing system 101 is possible to be flexibly constructed is obtained.

This is because the classification unit 110, the model construction unit 120, the terminal 102, the storage device 103, and the storage device 104 can be arbitrary connected to each other via the network 109.

### Second Example Embodiment

Next, a second example embodiment of the present invention will be described in detail with reference to a drawing. In the following explanation, the description will be appropriately omitted when the explanation has been made above and the additional explanation is not needed.

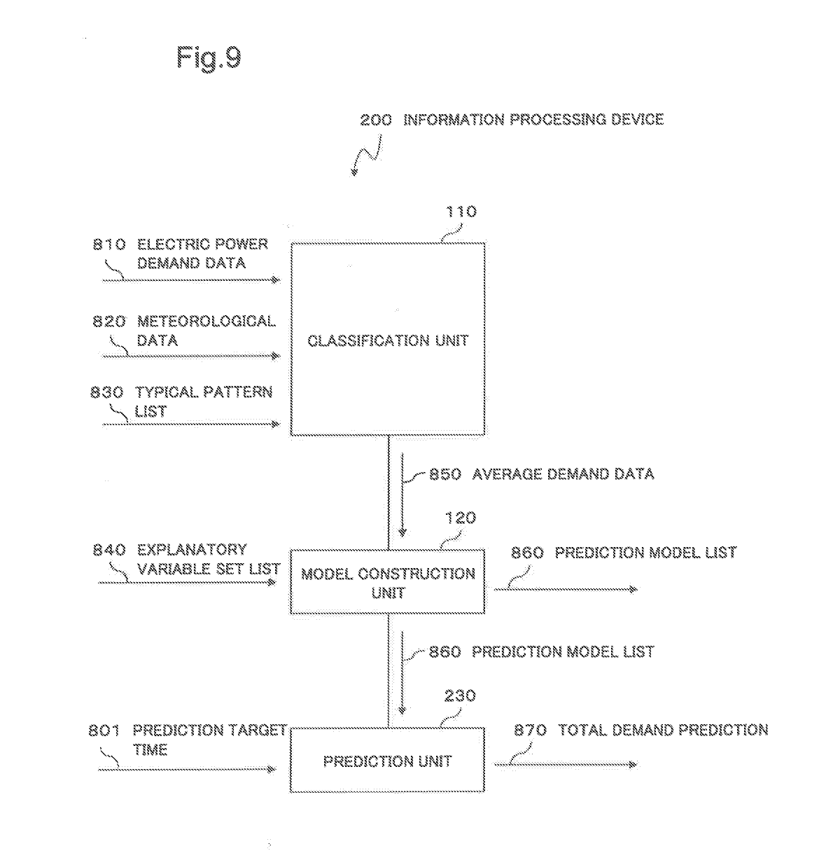

FIG. 9 is a block diagram showing a configuration of an information processing device 200 according to the second example embodiment of the present invention.

As shown in FIG. 9, the information processing device 200 according to this example embodiment has a different composition in further including a prediction unit 230. This is a difference between the information processing device 200 according to this example embodiment and the information processing device 100 according to the first example embodiment.

The information processing device 200 may be realized by the computer 700 shown in FIG. 2 like the information processing device 100.

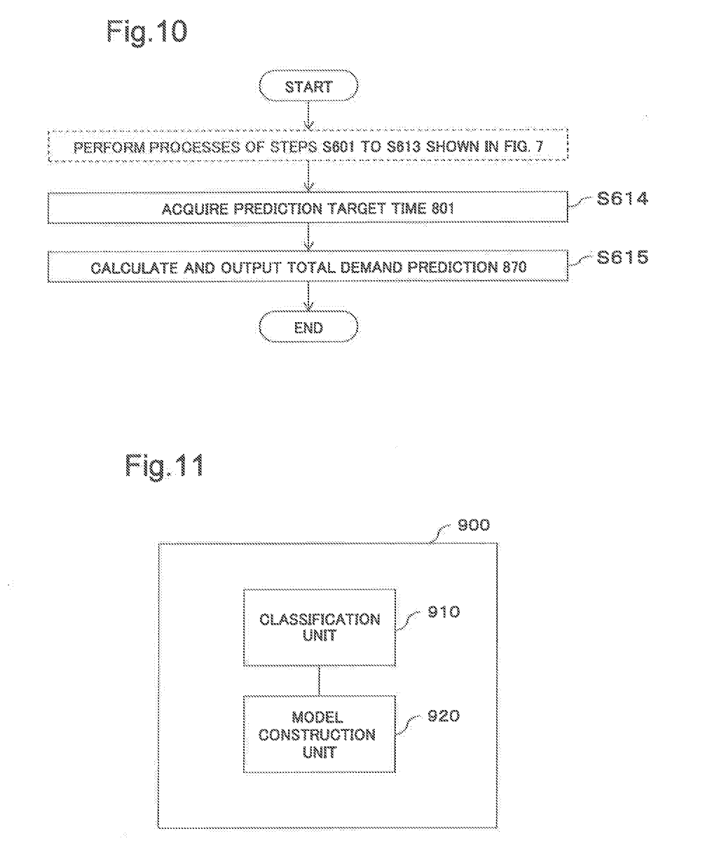

In this case, the CPU 701 further executes various processes according to the read program and based on the read data as the prediction unit 230 shown in FIG. 9. Here, the program is a program which causes the computer 700 to perform the operation shown in a flowchart of FIG. 10 described later.

Further, the memory 702 may store a prediction target time 801 and a total demand prediction 870. The memory 702 may be included in the prediction unit 230 as a part thereof.

Further, the storage device 703 may store the prediction target time 801 and the total demand prediction 870. Further, the storage device 703 may be included in the prediction unit 230 as a part thereof.

Further, the input unit 704 may be included in the prediction unit 230 as a part thereof.

Further, the output unit 705 may be included in the prediction unit 230 as a part thereof.

Further, the communication unit 706 may be included in the prediction unit 230 as a part thereof.

### Prediction Unit 230

The prediction unit 230 predicts the demand (the model demand) by the prediction model based on each of the prediction models included in the prediction model list 860. Next, the prediction unit 230 calculates a group demand by multiplying the model demand by the number of the contract units included in the group corresponding to the prediction model. Further, the prediction unit 230 calculates the total demand prediction 870 by summing all the group demands and output it.

Next, the operation of this example embodiment will be described in detail with reference to a drawing.

FIG. 10 is a flowchart showing the operation of this example embodiment.

The processes of steps S601 to S613 are the same as those of step S601 to S613 shown in FIG. 7.

Next, the prediction unit 230 acquires the prediction target time 801 (step S614). For example, the prediction unit 230 acquire the prediction target time 801 inputted by the operator via the input unit 704 shown in FIG. 2. Alternatively, the prediction unit 230 may receive the prediction target time 801 from an equipment (not shown) via the communication unit 706 shown in FIG. 2. Next, the prediction unit 230 calculates the total demand prediction 870 and outputs it (step S615).

For example, the prediction unit 230 outputs the total demand prediction 870 via the output unit 705 shown in FIG. 2. Further, the prediction unit 230 may transmit the total demand prediction 870 to the equipment (not shown) via the communication unit 706 shown in FIG. 2. Further, the prediction unit 230 may record the total demand prediction 870 in the recording medium 707 via the storage device 703 shown in FIG. 2.

Further, the prediction unit 230 may arbitrarily output the prediction target time 801, the model demand, and the group demand in addition to the total demand prediction 870 in a format that is recognizable to the person.

According to the example embodiment mentioned above, an advantageous effect in which a highly accurate electric power demand request can be provided in addition to the effect of the first example embodiment even when a plurality of consumers having different demand tendencies exist is obtained.

This is because the prediction unit 230 calculates the total demand prediction 870 based on the prediction model included in the prediction model list 860 and outputs it.

### <Modification Example of Second Example Embodiment>

The information processing system 101 shown in FIG. 8 may include the prediction unit 230. In this case, the prediction unit 230 may be connected to another component via the network 109. Alternatively, the prediction unit 230 may be directly connected to another component.

### Third Example Embodiment

FIG. 11 is a block diagram showing a configuration of an information processing device 900 according to a third example embodiment of the present invention. As shown in FIG. 11, the information processing device 900 includes a classification unit 910 and a model construction unit 920.

The classification unit 910 classifies a plurality of contract units into an arbitrary number of groups based on the feature of the demand changing in chronological order corresponding to each of the elements which is possible to influence the demand regarding the contract unit. The model construction unit 920 constructs the prediction model that is the model for predicting the demand regarding each group and outputs the constructed prediction model.

By employing the above-mentioned configuration, according to the third example embodiment, an advantageous effect in which the appropriate prediction model can be constructed even when a plurality of consumers having different demand tendencies exist, because the prediction model is constructed for each demand tendency.

Each component explained in each example embodiment described above may not necessarily exist independently of each other. For example, an arbitrary number of components may be realized as one module. Further, one arbitrary component among the components may be realized by a plurality of modules. Further, one arbitrary component among the components may be another arbitrary component among the components. Further, a part of one arbitrary component among the components and a part of another arbitrary component among the components may overlap each other.

Each component in each example embodiment mentioned above and the module for realizing each component may be realized by hardware if needed and possible. Further, each component and the module for realizing each component may be realized by a computer and a program. Further, each component and the module for realizing each component may be realized by the mixture of the hardware module, the computer, and the program.

The program is recorded in a computer-readable non-transitory recording medium such as for example, a magnetic disk, a semiconductor memory, or the like and provided for the computer. The program is read from the non-transitory recording medium by the computer at the time of booting the computer or another time. The read program, controls the operation of the computer and causes the computer to function as the component in each example embodiment.

Further, in each example embodiment described above, although a plurality of operations are described in turn in a flowchart format, the order of performing a plurality of the operations is not limited to the order described in the flowchart. Therefore, when, using each example embodiment, the order of performing a plurality of the operations can be changed if it does not have influence on the entire operation.

Moreover, in each example embodiment described above, a plurality of the operations are not necessarily performed at different timings, respectively. For example, during a period in which one operation is performed, another operation may start to be performed. Further, the time of performing one operation and the time of performing another operation may partially or wholly overlap each other.

Moreover, in each example embodiment described above, it is described, that after the completion of performing one operation, another operation is performed. However, this description does not limit a time relationship between the one operation and another operation. Therefore, when each example embodiment is performed, the time relationship between a plurality of the operations can be changed if it does not have influence on the entire operation. Further, the specific description of each operation of each component does not limit each operation of each component. Therefore, each specific operation of each component may be changed if it does not have influence on function, performance, and another characteristic when each example embodiment is performed.

The invention of the present application has been described above with reference to the example embodiment. However, the invention of the present application is not limited to the above mentioned example embodiment. Various changes in the configuration, or details of the invention, of the present application that can be understood by those skilled in the art can be made without departing from the scope of the invention of the present application.

This application is based upon and claims the benefit of priority from Japanese Patent Application No. 2014-246935 filed on Dec. 5, 2014, the entire disclosure of which is incorporated herein.

### INDUSTRIAL APPLICABILITY

The present invention can be applied to a demand prediction and a supply control of energy such as electric power, gas, or the like, tap water, cooking ingredient, food articles, information processing resources, communication processing resources, and the like.

### REFERENCE SIGNS LIST

100 information processing device
101 information processing system
102 terminal
103 storage device
104 storage device
109 network
110 separation unit
120 model construction unit
200 information processing device
230 prediction unit
700 computer
701 CPU
702 memory
703 storage device
704 input unit
705 output unit
706 communication unit
707 recording medium
801 prediction target time
810 electric power demand data
820 meteorological data
830 typical pattern list
840 explanatory variable set list
850 average demand data
860 prediction model list
870 total demand prediction.

1. An information processing device comprising;
a memory storing instructions; and
one or more processors configured to execute the instructions to:
classify a plurality of contract units into an arbitrary number of groups based on a feature of a demand that changes in chronological order corresponding to each of elements which is capable of influencing the demand regarding the contract unit; and
construct a prediction model that is a model for predicting the demand with respect to each group and output the constructed prediction model.

2. The information processing device according to claim 1, wherein one of a plurality of the elements is an arbitrary specific period on the time axis and another one of the plurality of the elements is an arbitrary specific meteorological condition.

3. The information processing device according to claim 1, wherein the feature of the demand changing in chronological order is represented by responsiveness of the demand regarding the element.

4. The information processing device according to claim 1, wherein
the one or more processors are further configured to execute the instructions to:
classify the contract unit into the group based on a similarity between a feature pattern showing a combination of the features of the demand changing in chronological order and a typical pattern indicating a combination of definitions of the responsivenesses corresponding to the elements.

5. The information processing device according to claim 4, wherein
the one or more processors are further configured to execute the instructions to:
acquire an explanatory variable set based on the typical pattern corresponding to the group and construct the prediction model with respect to an average value of each of the demands regarding the contract units included in the group by using the acquired explanatory variable set.

6. The information processing device according to claim 1, wherein
the one or more processors are further configured to execute the instructions to:
predict a model demand that is a predicted demand by the prediction model, calculating a group demand by multiplying the model demand by the number of the contract units included in the group corresponding to the prediction model, and calculating a predicted total demand by summing the group demands corresponding to all the groups.

7. The information processing device according to claim 8, wherein
the one or more processors are further configured to execute the instructions to:
output the model demand and the group demand.

8. The information processing device according to claim 1, wherein
the one or more processors are further configured to execute the instructions to:
output information regarding the correspondence between each of the contract units and each of the groups, information regarding the correspondence between each of the groups and the typical pattern, and information regarding the correspondence between each of the typical patterns and each of the explanatory variable sets,

9. A model construction method comprising:
classifying a plurality of contract units into an arbitrary number of groups based on a feature of a demand that changes in chronological order corresponding to each of elements which is capable of influencing the demand regarding the contract unit; and
constructing a prediction model that is a model for predicting the demand with respect to each group and outputting the constructed prediction model
by a computer.

10. A computer program storage medium storing a program that causes a computer to execute:
a process that classifies a plurality of contract units into an arbitrary number of groups based on a feature of a demand that changes in chronological order corresponding to each of elements which is capable of influencing the demand regarding the contract unit; and
a process that constructs a prediction model that is a model for predicting the demand with respect to each group and outputs the constructed prediction model.

11. The information processing device according to claim 2, wherein the feature of the demand changing in chronological order is represented by responsiveness of the demand regarding the element.

12. The information processing device according to claim 2, wherein
the one or more processors are further configured to execute the instructions to:
classify the contract unit into the group based on a similarity between a feature pattern showing a combination of the features of the demand changing in chronological order and a typical pattern indicating a combination of definitions of the responsivenesses corresponding to the elements.

13. The information processing device according to claim 3, wherein
the one or more processors are further configured to execute the instructions to:
classify the contract unit into the group based on a similarity between a feature pattern showing a combination of the features of the demand changing in chronological order and a typical pattern indicating a combination of definitions of the responsivenesses corresponding to the elements.

14. The information processing device according to claim 2, wherein
the one or more processors are further configured to execute the instructions to;
predict a model demand that is a predicted demand by the prediction model, calculating a group demand by multiplying the model demand by the number of the contract units included in the group corresponding to the prediction model, and calculating a predicted total demand by summing the group demands corresponding to all the groups.

15. The information processing device according to claim 3, wherein
the one or more processors are further configured to execute the instructions to;
predict a model demand that is a predicted demand by the prediction model, calculating a group demand by multiplying the model demand by the number of the contract units included in the group corresponding to the prediction model, and calculating a predicted total demand by summing the group demands corresponding to all the groups.

18. The information processing device according to claim 4, wherein
the one or more processors are further configured to execute the instructions to:
predict a model demand that is a predicted demand by the prediction model, calculating a group demand by multiplying the model demand by the number of the contract units included in the group corresponding to the prediction model, and calculating a predicted total demand by summing the group demands corresponding to all the groups.

17. The information processing device according to claim 5, wherein
the one or more processors are further configured to execute the instructions to:
predict a model demand that is a predicted demand by the prediction model, calculating a group demand by multiplying the model demand by the number of the contract units included in the group corresponding to the prediction model, and calculating a predicted total demand by summing the group demands corresponding to all the groups,

18. The information processing device according to claim 2, wherein
the one or more processors are further configured to execute the instructions to;
output information regarding the correspondence between each of the contract units and each of the groups, information regarding the correspondence between each of the groups and the typical pattern, and information regarding the correspondence between each of the typical patterns and each of the explanatory variable sets,

19. The information processing device according to claim 3, wherein
the one or more processors are further configured to execute the instructions to:
output information regarding the correspondence between each of the contract units and each of the groups, information regarding the correspondence between each of the groups and the typical pattern, and information regarding the correspondence between each of the typical patterns and each of the explanatory variable sets.

20. The information processing device according to claim 4, wherein
the one or more processors are further configured to execute the instructions to:
output information regarding the correspondence between each of the contract units and each of the groups, information regarding the correspondence between each of the groups and the typical pattern, and information regarding the correspondence between each of the typical patterns and each of the explanatory variable sets.
